(19) United States
(12) Patent Application Publication
(10) Pub. No.: US 2002/0185581 A1
(43) Pub. Date: Dec. 12, 2002

(54) Bicycle seat elevation adjuster

(76) Inventor: Brian C. Trask, Salt Lake City, UT (US)

Correspondence Address: BRIAN C. TRASK, 3601 EAST HERMES DRIVE, SALT LAKE CITY, UT, 84124, US

(21) Appl. No.: 10/166,590

(22) Filed: Jun. 10, 2002

Related U.S. Application Data
(60) Provisional application No. 60/296,908, filed on Jun. 11, 2001.

(51) Int. Cl. B62J 1/00; F16M 11/00

(52) U.S. Cl. 248/408; 248/407; 297/215.13

(57) ABSTRACT

A bicycle seat support structured to improve a rider's ability to change a seat's elevation, while riding safely, between a high position for ergonomic pedalling and a low position for hill descent.

### RELATED APPLICATIONS

This application claims the benefit under 35 U.S.C. 119(e) of the filing date of Provisional Application Ser. No. 60/296,908, filed Jun. 11, 2001, for “BICYCLE SEAT ELEVATION ADJUSTER”.

### BACKGROUND

1. Field of the Invention

This invention relates to mechanisms useful to vary the elevation for a support on which a person may sit. It is particularly directed to a seat post for a bicycle that is safely adjustable in elevation while riding the bicycle.

2. State of the Art

When riding a bike, particularly the type of bike characterized as a “mountain bike”, it sometimes is desirable to change the elevation of the seat with respect to the frame. For example, when riding on a level surface, it is desirable for a rider's leg to extend substantially straight at the bottom of the pedal stroke to optimize efficient and ergonomic use of the leg muscles. When riding down a steep hill, it is preferred to lower the seat, thereby allowing a rider to sit lower on the bike, changing the location of the center of gravity of bike and rider rearward, and lower, for a more stable riding position. To avoid being pitched over the handle bars when a front brake is applied, the center of gravity for the rider and bike must remain behind a plumb line drawn through the point of contact between the front wheel and the ground. When riding down particularly steep hills, a low seat also permits a rider to move his body even further rearward, behind the seat and essentially standing, thereby to maximize a rearward shift in center of gravity.

Commercially available bicycles generally have seats which may be changed in elevation by manually loosening a lever actuated seat post clamp, moving the seat post to the desired elevation, and then tightening the clamp. Considerable force is required to tighten the lever actuated clamp to ensure the seat will not move from the desired elevation under the rider's weight, especially when riding on a bumpy surface. The tightened clamp fixes the seat post relative to the bicycle frame and maintains the seat at the desired elevation. However, such a clamp can not realistically be safely operated while a rider is riding the bicycle. Any such mechanism requiring a rider to remove a hand from the handlebars for an extended period of time, or to operate a mechanism requiring a rigorous application of force with the potential to cause an instability, can not be characterized as being safe to operate while riding. A rider would likely fall off his bike, or drive off a trail or into traffic, while attempting to operate a mechanism such as the ubiquitous clamp. Adjustment in seat elevation therefore requires a rider to stop, dismount his bicycle, release the clamp, adjust the seat post elevation, and tighten the clamp.

For racers, and others desiring uninterrupted riding, such stopping to adjust a seat elevation effectively precludes changing seat elevation during a bike ride. Their bicycle seats typically are set to a “tolerable” elevation and left at that elevation for the entire ride. Therefore, either the rider's pedal stroke is compromised, with resulting reduced ergonomic power and efficiency, or the rider's center of gravity is unsafely supported more forward than desirable on steep descents.

Certain attempts have been made to increase adjustability of a bicycle seat height. Cienfuegos, in U.S. Pat. No. 5,044,592, titled “ADJUSTABLE SEAT FOR BICYCLES AND THE LIKE” discloses an adjustable seat post with a spring biased mechanism to hold the post at a variety of elevations. However, his post is not safe to adjust while in the act of riding a bicycle, because a rider must remove a hand from a handlebar, locate and actuate the release mechanism, control the seat elevation adjustment, then finally, the rider can let go of the release mechanism. Therefore, a rider is exposed to risk of loosing control of his bicycle for an unsafe interval if the seat elevation is adjusted as he is riding. Furthermore, the rider is at least partially distracted from riding, during the unsafe interval, as he must control the seat elevation and acquire feedback that the seat is in position for engagement of the post and holding structure. A similarly unsafe seat elevation adjusting mechanism is disclosed by Duncan, in U.S. Pat. No. 6,202,971, titled “ADJUSTABLE HEIGHT SEAT SUPPORT”.

An alternative mechanism to adjust the position of a bicycle seat is disclosed in an advertisement printed on page 25 of the June 1994 edition of Mountain Bike magazine. The device is known as a Power Post, and can move a seat between several elevations while simultaneously translating the seat forward and rearward optimally to assist in locating a rider's center of gravity. The changes in seat elevation are made by a rotating linkage of the Power Post, while a post portion remains at a fixed elevation in a conventional post clamp. The Power Post is thought to be rather complex and therefore prohibitively expensive.

A need still remains for a seat support for a bicycle that is inexpensive, rugged, and that can safely be adjusted in elevation while in the act of riding the bicycle.

### BRIEF SUMMARY OF THE INVENTION

The present invention provides an apparatus and method for safely adjusting a bicycle seat elevation while riding a bicycle on which the seat is mounted. This invention includes a release mechanism and a retaining mechanism adapted cooperatively to permit changes in elevation of a bicycle seat while riding the bicycle. The retaining mechanism typically releasably holds a seat post, supporting a seat, at a plurality of fixed elevations with respect to a bike frame member. Preferred embodiments have a release mechanism which may be mounted on the handlebars, horizontal frame member or tube, or in any other location convenient for access while riding the bike. One preferred arrangement for the release mechanism mount is as a thumb-actuated lever mounted on a handlebar. Such an arrangement can be in association with a gear shifter, such as an index shifter. In any case, operation of the release mechanism permits lowering the seat to a new elevation with respect to the bike frame. The release mechanism may safely be operated while in the act of riding the bike, thereby permitting changes in bike seat elevation without dismounting from the bike.

Certain embodiments of the invention may permit the seat to be raised in elevation without operation of a release mechanism; the rider may simply lift the seat with his hand, or by clenching it between his thighs and straightening his legs. In such certain embodiments, a rider may remove a hand from a handlebar to safely raise a seat because the application of force to a seat is in a stable vertical direction, and effecting an elevation change does not require a significant amount of time or effort. A force may quickly and safely be applied to a seat in a vertical direction because the line of action of the applied force is in a stable, up-down, direction for a rider. A rider's hand must leave the handlebar for only a very short time interval, travel to an easily reached position, and lift in a stable direction for the rider. The seat may therefore safely be ratcheted into a new elevation, with as many possible seat elevations as provided by a given retaining mechanism and seat post configuration.

According to principals of the instant invention, any desired fixed elevation change may be provided between two (or more) available positions of engagement between the retaining mechanism and the seat post. For example, a racer or mountain biker may know his preferred change in elevation between best pedalling stroke and desired lowest seat height. That distance for change in elevation can be established as the top and bottom engagement positions of a seat post and retaining mechanism, which may be the only positions in which the retaining mechanism engages with the post. Once the retaining mechanism is released from the top position, the seat may drop, or be slid under the rider's weight, directly to the desired lower engagement position. A biasing element, such as a compression spring, desirably is located to be effective as an assist in raising the seat.

It is within contemplation that a retaining mechanism can be structured as a brake mechanism attached to a seat post and arranged to fit inside a vertical bike frame member for frictional engagement with the inside diameter surface of the tube. An exemplary such brake may be configured as a cartridge, and can be actuated by a cable or hydraulic fluid. An infinite range of vertical fixed support positions, between a maximum and minimum, are achievable in such a configuration. Such a brake mechanism may provide support to a seat at a virtually infinite number of elevation positions. It currently is preferred to orient structure of the brake such that a weight applied to a seat additionally energizes the engagement between the brake and bicycle frame tube. An alternative mechanism having similar operating characteristics is a plate clutch, which can be adapted adjustably to hold a seat post at a plurality of desired elevations. A seat supported by certain embodiments of a plate clutch can be raised without necessarily requiring operation of a release mechanism.

In any event, it generally is desirable in certain embodiments of the invention that a provision be made to maintain the seat in a substantially uniform alignment facing forward when the retaining mechanism is engaged. In certain preferred embodiments, a provision may be made to maintain the seat orientation to face in substantially the same forward direction throughout the range of vertical adjustment. Maintaining such alignment aids in engagement of the retaining mechanism to a seat post. Maintaining the seat in a forward facing orientation, or resisting rotation of the seat about the post, can be a convenience for the rider. However, the rider can also orient the seat, if required, either by aiming the seat while holding the seat between his inner thighs, or by manipulating the seat by hand.

A preferred embodiment of the invention may be characterized as an adjustable bicycle seat support. The seat support typically includes a seat post capable of attachment in telescopic and vertically adjustable relation to a frame member of a bicycle and a retaining mechanism configured and arranged releasably to hold the post in one of a plurality of fixed vertical positions relative to the frame member. In certain embodiments, the retaining mechanism is operable to release the post to accomplish a change in elevation of the post while the retaining mechanism remains at a fixed distance from the frame member. Certain retaining mechanisms can be constructed and arranged in harmony with a post to permit a change in elevation of a bicycle seat, between held positions, of less than about ¼ inch. Other devices have a post that is holdable, by structure carried by the retaining mechanism, at only a high position and a low position In such devices, the distance between the high seat position and the low seat position generally is a fixed increment between about 2 and about 5 inches.

The device also typically includes a release mechanism, safely operable while a rider is in the act of riding the bicycle, which is operable to release engagement of the retaining mechanism from a seat post, whereby to permit an adjustment in elevation of the post with respect to a bicycle frame member. Preferably, the release mechanism is constructed and arranged to permit a change in seat elevation without requiring a rider to remove his hands from a handlebar of the bicycle. In some embodiments, the retaining mechanism is carried on a tubular member that is adapted for telescopic registration in the bicycle frame. In other embodiments, the retaining mechanism is carried on structure associated with a frame of the bicycle.

Certain embodiments also include alignment structure adapted to maintain a seat in an approximately forward facing direction during changes of elevation of the seat. One preferred alignment structure can also resist displacement of the post beyond an upper and a lower bound. An exemplary alignment structure includes a channel formed in a post and indexing structure configured and arranged for sliding reception in the channel as the post is raised and lowered. The channel and the indexing structure can operate in harmony as stops to limit a maximum displacement of the post.

The invention can also be broadly described as an adjustable bicycle seat support, including a seat post, a retaining mechanism, and a release mechanism. The release mechanism desirably is safely operable while a rider is in the act of riding the bicycle, and is operable to release engagement of the retaining mechanism from the post, whereby to permit a telescoping adjustment in elevation of the post. Such “safe” release mechanisms permit a change in seat elevation without requiring a rider to remove his hands from a handlebar of the bicycle.

Embodiments preferably include alignment structure adapted to maintain a forward orientation of the post during changes in its elevation. Certain alignment structure can operate in harmony with structure of the retaining mechanism to define a maximum and a minimum height to which the seat post may be adjusted. One alignment structure enables holding structure of the retaining mechanism to be withdrawn from engagement with receiving structure of a post while indexing structure of the retaining mechanism remains in engagement with alignment structure of the post.

In some embodiments, a holding interface between the seat post and the retaining structure can be overridden, by a rider, to effect an increase in seat post elevation without actuating a release mechanism. Furthermore, structure of the retaining mechanism desirably is adapted for progressive engagement with receiving structure of a seat post, whereby to resist wobble of a held seat post.

### BRIEF DESCRIPTION OF THE DRAWINGS

In the drawings, which illustrate what are currently regarded as the best modes for carrying out the invention:

FIG. 1 is a side view in elevation of a rider on a bicycle having an elevated seat and riding on a horizontal surface;

FIG. 2 is a side view in elevation of the bicycle and rider of FIG. 1 on a maximum angle hill;

FIG. 3 is a side view in elevation illustrating the increased maximum hill angle for the bicycle and rider of FIG. 2, but with a lowered seat;

FIG. 4 is a side view in elevation illustrating the further increased maximum hill angle of the bicycle and rider of FIG. 3 subsequent to a rearward shift in rider position;

FIG. 5 is a side view in elevation of a portion of a bicycle frame showing a first embodiment of an adjustable seat support according to the invention;

FIG. 6 is an elevation view in section, taken through a midplane of a second embodiment similar to that illustrated in FIG. 5;

FIG. 7 is a view similar to that illustrated in FIG. 6, but of a third embodiment including a release mechanism having a plunger;

FIG. 8 is a view similar to that illustrated in FIG. 7, illustrating a fourth embodiment including a release mechanism having indexing structure;

FIG. 9 is a perspective view of a portion of a seat post;

FIG. 10 is a view in perspective of retaining structure adapted to interface with the seat post of FIG. 9;

FIG. 11 is a perspective view of a portion of an alternative seat post;

FIG. 12 is a view in perspective of retaining structure adapted to interface with the seat post of FIG. 11;

FIG. 13 is a perspective view of a portion of a third seat post;

FIG. 14 is a view in perspective of retaining structure adapted to interface with the seat post of FIG. 13;

FIG. 15 is a top view, partially in section, of an alternative seat post and retaining mechanism;

FIG. 16 side view in section of a portion of a seat post and another alternative retaining structure;

FIG. 17 is a side view in elevation of a portion of a bicycle frame and yet another alternative retaining mechanism;

FIG. 18 is a side view in elevation, partially in section, of the retaining mechanism of FIG. 17;

FIG. 19 is a top view of an alternative clutch plate.

### DETAILED DESCRIPTION OF THE ILLUSTRATED EMBODIMENTS

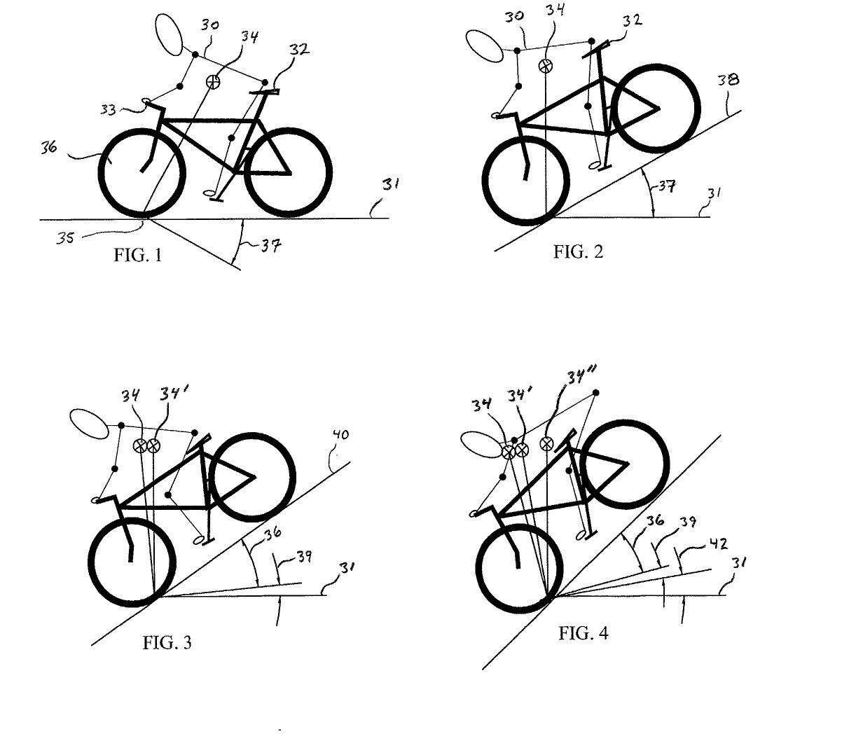

As additional background for the needs fulfilled by the invention, FIG. 1 illustrates a bicycle rider 30 riding on a horizontal reference surface 31 and with his bicycle seat 32 in an elevated position for most ergonomic and efficient pedalling. The rider 30 will not tip over his handlebars 33 until his center of gravity 34 passes beyond the contact spot 35 between his front wheel 36 and the ground 31. The maximum angle of a hill, down which the rider can ride while in the illustrated most ergonomic pedalling position, is indicated generally at 37. FIG. 2 illustrates that maximum hill at 38. If the hill 38 steepens, or if the rider 30 applies his front brake, he unavoidably will tip over his handlebars 33.

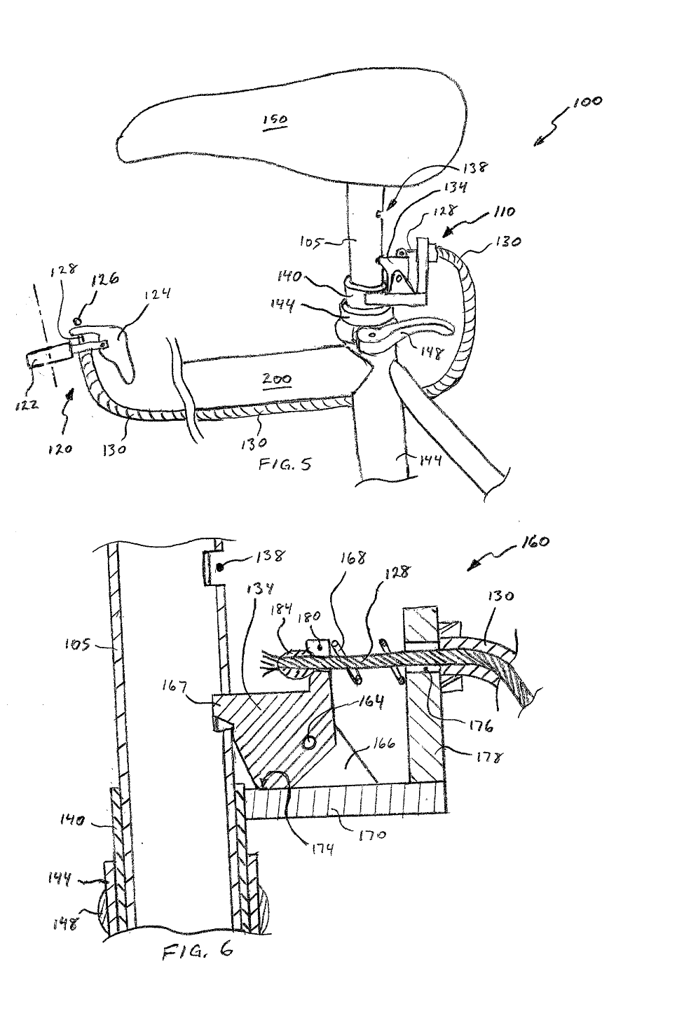

To avoid doing such an endo maneuver, most riders intuitively will try to move their bodies to create a new center of gravity 34′ at a more rearward location. One way to accomplish such a change in center of gravity location is simply to lower the seat 32, as illustrated in FIG. 3. Lowering the seat 32, as illustrated, increases the critical hill angle by the angle indicated at 39. Now the rider 30 can either descend a hill 40 at up to the critical angle, or a less steep hill and be able to apply at least some front braking power. Sometimes it is necessary to descend a hill even more steep than hill 40, so a rider must move his center of gravity even more extreme rearward to 34″. Such a move entails moving his buttocks to a position straddelling, and actually to the rear of, the seat 32, and requires him to stand on the pedals. As illustrated in FIG. 4, the critical angle for rider 30 can increase by an additional angle indicated at 42. Making such an extreme rearward body shift is impossible with a seat 32 at an elevated position, such as the elevation illustrated in FIGS. 1 and 2.

Widely used and commercially available mechanisms, operable to change a bicycle seat's elevation, generally require a rider to stop moving and effectively dismount from the seat 32 to manipulate a locking lever. Such stopping in the middle of a riding experience is often undesirable, so many riders compromise the elevation of their seats, which sacrifices some ergonomic efficiency, but enhances their control over the location of their center of gravity. The invention is structured to improve a rider's ability to change a seat's elevation, while riding safely, between a high position for ergonomic pedalling and a low position for hill descent.

As illustrated in FIG. 5, a first preferred embodiment of the invention, generally indicated at 100, includes a seat post 105, a retaining mechanism, generally indicated at 110, and a release mechanism, generally indicated at 120. It is desirable to mount a release mechanism, such as mechanism 120, at a location suitable to permit its safe operation without requiring a rider to remove a hand from the handlebars of a bicycle. Release mechanisms may be mounted on a handlebar, frame member, or even in, or on, a seat. Frame-mounted release mechanisms may safely be operated by actuating them with some portion of a rider's leg. Similarly, a seat-mounted release mechanism may be actuated by squeezing the mechanism between the rider's thighs.

The release mechanism 120, illustrated in FIG. 5, is structured for attachment by a conventional split ring 122 to a handlebar cross member. A rider conveniently may actuate release mechanism 120 by pressing pivotally mounted lever 124 with a thumb or finger. A cable stop 126 is provided at the end of cable 128 for displacement by lever 124. Therefore, as lever 124 rotates under thumb or finger pressure, it causes a length of cable 128 to be extracted from cable housing 130. The opposite end of cable 128 can then displace structure to operate a retaining mechanism. Cable 128 typically has an in-line take-up adjustment (not illustrated) operable to change an effective length of a cable housing to tension and/or assist in installation of a cable.

As release mechanism 120 is actuated, an opposite end of cable 128 retracts the rotatable pawl 134 from engagement with post 105. Pawl 134 is structured to engage receiving structure, generally indicated at 138, carried by post 105. Retaining structure 110 is affixed to tubular member 140. When post 105 is not held by retaining mechanism 110, post 105 is free to telescope up and down with respect to holding structure, such as tube section 140. Tube 140 may be adjusted to a desired height in vertical bicycle frame member 144, and held at that position by rotating clamp 148 into a locked position. When tube 140 is locked in position, the retaining mechanism 110 is held at a fixed position with respect to frame members of the bicycle. Such a fixed location is advantageous for routing cables, such as cable 130. Therefore, effecting a change in elevation of the seat 150 by operation of the invention causes a change in the distance between the seat 150 and the retaining mechanism 110. It is within contemplation, although not preferred at this time, alternatively to mount a retaining mechanism to remain at a fixed distance from a seat.

Typically, to position the seat 150 at a most ergonomically efficient pedalling height, a rider will first adjust the height of post 105 in tube 140 to a maximum elevation. Then, the height of tube 140 with respect to tube 144 is selected and fixed by operation of clamp 148. Subsequent changes in elevation of seat 150 are safely accomplished, even while riding, using the release mechanism 120 to disengage retaining mechanism 110 from post 105, permitting the post 105 to slide within tube 140.

Additional details of construction of a retaining mechanism similar to mechanism 110, and generally indicated at 160, are illustrated in FIG. 6. Retaining mechanism 160 includes a pawl 134 rotatably mounted on axle 164 and axle support structure 166. It generally is preferred for a retaining structure, such as tooth 167 of pawl 134, to be biased toward holding engagement with receiving structure, such as aperture 138 of post 105, by a resilient element, such as by coil spring 168. To increase ruggedness, a pawl 134 desirably is constructed substantially to transfer weight loads from a post 105 directly to rugged weight-holding structure, such as a support plate 170. One way to effect such transfer of load is illustrated in FIG. 6, generally at 174, where a surface of pawl 134 contacts plate 170 to effect direct transfer of weight loads from post 105 to plate 170.

Also detailed in FIG. 6 is one way to attach an end of a cable 128 to a pawl 134 to enable remote actuation of the release mechanism 160. An end of cable 138 is fed through an aperture 176 in end plate 178, through spring 168, and is received in a slot 180 in pawl 134. A swaged end stop 184, having a size larger than the slot 180, is held in a enlarged area or countersink in pawl 134, and can therefore apply a tipping load on the pawl 134 to rotate pawl 134 about axle 164.

A third embodiment of a retaining mechanism, generally indicated at 190, is illustrated in FIG. 7. Retaining mechanism 190 includes structure, to interface with a seat support post, that is formed as a plunger 192. Plunger 192 is slidingly disposed in a housing, generally indicated at 194. An interface portion, or distal tip 196, can be constructed to interface in a holding relation with receiving structure carried by a post 105, such as aperture 138.

Although the illustrated embodiment 192 can be substantially rectangular or square in a cross-section taken perpendicular to the page, a cross-section of a plunger may take any form, including having the round cross-section of a cylinder. Floor plate 198 of housing 194 can also function to attach housing 194 to a tube section 140. Such an attachment typically is formed by brazing, welding, or screwing the two components together. Alternatively, in certain embodiments of the invention, a housing, such as housing 190, can be attached directly to structure of the bicycle frame, such as to horizontal tube 200 (see FIG. 5).

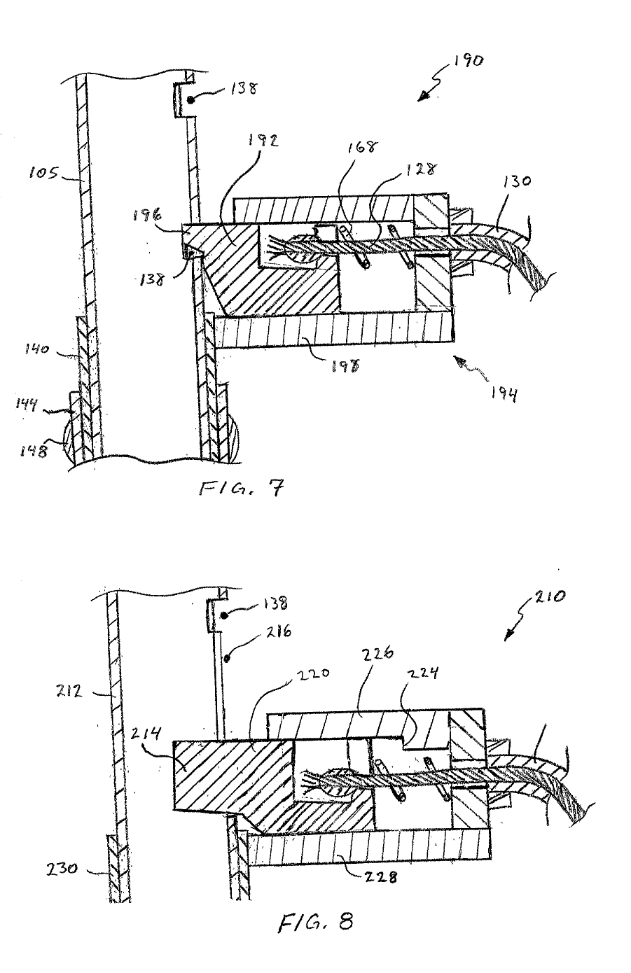

It is desirable that a seat 150 remains in a substantially forward-facing orientation while an elevation adjustment is made. Such orientation permits reliable engagement of retaining structure of a retaining mechanism, such as distal tip 196, in receiving structure, such as a socket 138 of seat post 105. A guide structure may therefore be included in certain embodiments of the invention to assist in orientation of a seat 150 between different elevations. One such seat orienting guide structure is illustrated in a fourth embodiment of a retaining mechanism, generally indicated at 210, in FIG. 8.

In the retaining mechanism 210 illustrated in FIG. 8, an orientation of a seat post 212 is determined by an interference between index structure 214 and guide channel 216. Guide structure 214 is slidingly captured in channel 216. It is desirable to resist decoupling between guide structure 214 and channel 216 to prevent misalignment of a seat 150. One way to prevent separation between the two components is to limit a retraction distance through which plunger 220 may travel. One way to impose such a travel limitation is illustrated as a displacement stop 224, formed as a shoulder in housing 226. Of course, other arrangements to impose control over retraction displacement of retaining structure is also workable. One such alternative arrangement to limit retraction displacement for retaining structure may be imposed by a displacement limit imposed on, or inherent in, a release mechanism.

Housing 226 generally is constructed to hold retaining structure 220 and attach to support plate 228. In any case, retaining structure 210 is configured to permit assembly of a post 212 into engagement with alignment structure 214 and receiving tube 230. An order of component assembly may be required, such as first placing tube 212 into engagement with tube 230, then attaching mechanism 210 to locate guide structure 214 in engagement with a guide channel 216. Support plate 228 may be affixed to tube 230, or attached to other structure of a bicycle, such as horizontal tube 200 (see FIG. 5). Tube 230 can be an intermediate, and height adjustable, tube section, such as tube 144. Alternatively, tube 230 can be the vertical bicycle frame tube 144.

It is desirable for an interference to be formed such that the post 212 cannot accidentally be removed from a bicycle while attempting to adjust the elevation of a seat 150. Certain embodiments of the invention provide a structural interference to form a stop position at a maximum seat height. The invention may also include a stop for a minimum seat height. Furthermore, is advantageous for the maximum upper and lower seat stop elevations, if present, to correspond to mating elevations for retaining structure, such as 196, and receiving structure 138. An operable such structural interference conveniently can be formed between seat orientation guide structure, such as orientation guide 214, and the top and bottom of channel 216 in post 212.

FIG. 9 shows a post 105 and receiving structure 138 at two locations for engagement with a holding or retaining mechanism at corresponding high and low seat positions. In embodiments having only two elevation stops 138, the stops 138 are typically spaced apart by between about 2 and 5 inches. An additional plurality of such retaining structure 138 may be present in variations to a seat post 105, to provide additional adjustability for a seat elevation. As illustrated in FIG. 10, retaining structure 196, carried by plunger 192, is adapted to engage with receiving structure 138 to hold a seat at a fixed elevation.

It sometimes is desirable to provide an interface between receiving and retaining structure adapted to resist wobble of a retained seat post. Wobble may encompass rotational and/or vertical movement. Although a certain amount of wobble is acceptable, some riders desire minimal wobble. One wobble resisting interface is created by a draft, or taper, on sides of retaining structure 196. A plunger 192 may be permitted to move toward a post 105 for progressive engagement until the tapered portion is snugly received on side edges of receiving structure 138.

Sometimes it is desirable to provide an alignment maintaining structural interference to assist in forming an engagement between receiving and retaining structure. In the post 105 of FIG. 9, such structure may include a vertically disposed slot on an opposite side of the tube 105, in which a dowel or tongue may slide. The post 234, illustrated in FIG. 11, includes alignment structure (slot 236) and receiving structure (holes 238) on the same side of the post 234. Retaining structure 240, carried on plunger 220, fits into engagement with a hole 238. Alignment structure 214 slides in slot 236 (or slot 216 in FIG. 8) to keep a seat 150 facing in a forward direction while making an elevation change.

FIG. 13 illustrates a solid post 244 with a shallow guide channel 246 and three deeper elevation stops 248. The plunger 250 of FIG. 14 is sized to slide vertically as index structure in slot 246 between reception in individual of elevation stops 248. Plunger 250 can be a simple section cut from bar or extruded stock, and optionally can be formed to have shapes other than illustrated. A shape of holding structure, such as a plunger, generally is matched to operate in harmony with the shapes of an alignment slot (if present) and elevation stops. An interface between plunger 250 and a retraction structure, such as a cable 128, is not illustrated. A release mechanism for plunger 250 desirably is structured to extract the forward portion of plunger 250 from reception in a stop 248, but still maintain the tip 252 of plunger 250 in indexing engagement with alignment slot 246.

FIG. 15 illustrates another embodiment of a retaining mechanism and alignment structure. The retaining mechanism, generally indicated at 254, includes a plunger 256 that is biased toward engagement with receiving structure carried by post 258. A biasing element, spring 260, is compressed in housing 262 as plunger 256 is retracted from engagement with seat post 258. Lever 264 is pivotally mounted on axle 266, and engages plunger 256 inside socket 268. Rotation of lever 264 by cable 128 retracts plunger 256 away from post 258. Post 258 is slidably disposed in a tube 230. A dowel or tongue 270, affixed to tube 230, slides in a channel formed by a folded wall of tube 258 to keep a seat 150 aligned between elevations. Index structure 270 may alternatively slide in a channel or slot machined in a seat tube to serve as an alignment guide.

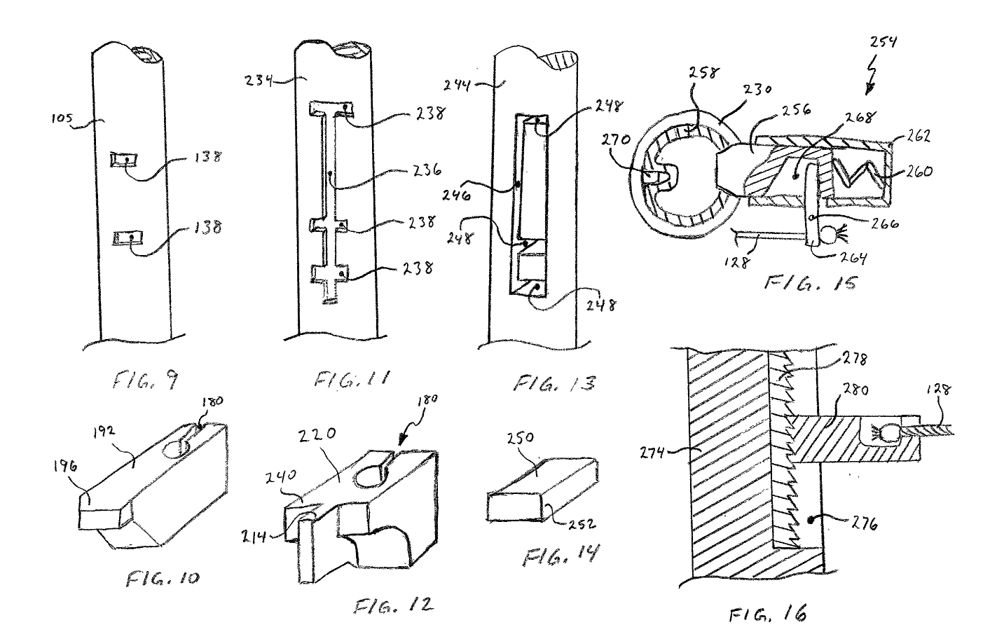

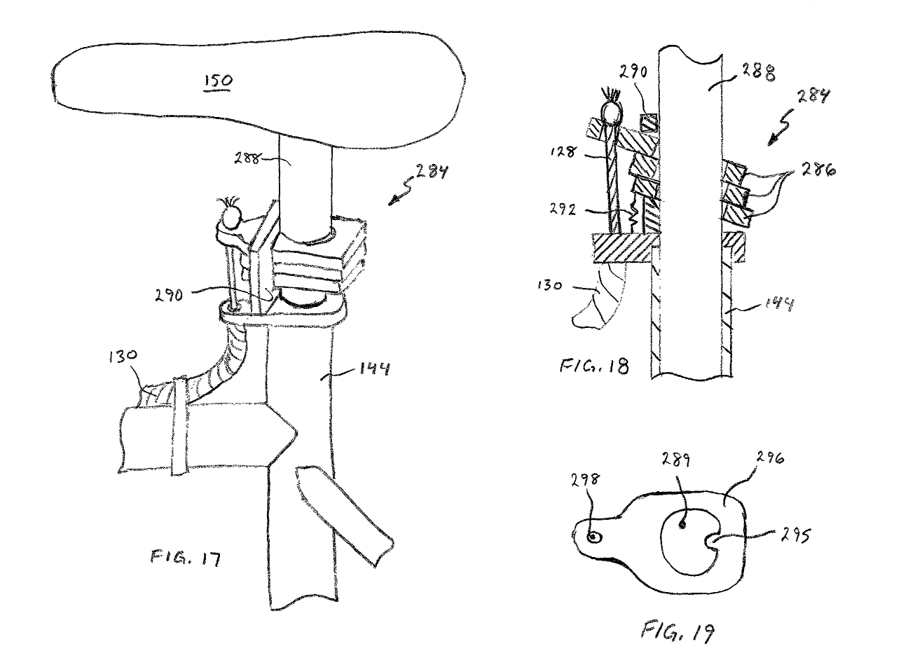

FIG. 16 illustrates another embodiment of the invention with a solid seat post 274 having alignment and receiving structure adapted to engage retaining structure. Alignment structure 276 is a channel machined from, or otherwise formed in, the solid post 274. Receiving structure 278 is a rack of generally triangular gear teeth. Plunger 280 has a forward end comprising a flat gear with approximately triangular teeth, and is biased toward mating engagement with rack 278. In certain embodiments, post 274 may be raised to a new elevation simply by lifting a seat 150, and without activating a remote release mechanism. Certain other embodiments of the invention similarly can be operated in such manner. For example, when a post 274 is pulled upward, the angled surface of the forward faces of the gear teeth cooperatively can displace a biased plunger 280, and permit a ratcheting upward of the seat post 274. As an auxiliary functionality, top and bottom ends of slot 276 may serve as displacement limits, in cooperation with plunger 280, to define maximum and minimum seat elevation adjustment positions.

A height change for a seat 150 of less than about ⅛ inch (or the size of a gear tooth), can be accomplished with the retaining arrangement illustrated in FIG. 16. Certain embodiments of the invention permit even smaller adjustments in elevation of a seat. One example of such an embodiment includes a plate-clutch retaining mechanism, generally indicated at 284 in FIG. 17, that can be adjusted to change a seat's elevation by a virtually infinitely small amount. As illustrated in FIG. 18, holding mechanism 284 includes a plurality of plates 286 fitting around seat post 288. As illustrated in FIGS. 18 and 19, a hole 289 passing through a plate 286 has a diameter slightly larger than a diameter of post 288 so that a rotation of the plates 286 about a pivot provided by vertical support 290 brings opposite top and bottom edges of the plate 286 into holding engagement with the post 288. A biasing element, such as compression spring 292, typically is provided to assist in operation of the clutch 284.

Post 288 may be solid or hollow. A post 288 having a smooth outside diameter permits infinitely small changes in seat elevation. A post 288 can also be constructed having texture, such as rings or dents, configured to interface with the comer structure of one or more plates 286 to augment holding power of the mechanism 284 and provide discrete elevation locations for holding a seat. Certain alternative post embodiments may additionally provide a channel structure to interface with indexing structure 295 carried by an alternative plate 296 to keep a seat aligned in a forward direction during elevation changes. Plate 296 also illustrates one way, at cable receiving hole 298, to couple a remote actuator to the retaining mechanism 284.

A retaining mechanism can be structured as a brake mechanism attached to a seat post and arranged to slide inside a vertical bike frame tube for frictional engagement with the inside diameter surface of the vertical tube. An exemplary such brake may be configured as a cartridge, and can be actuated to release its hold on a tube by a cable or hydraulic fluid. A cartridge brake may include a plurality of brake shoe elements that are spring-biased into engagement with the vertical tube wall. An infinite range of vertical fixed support positions, between a maximum and minimum, are achievable in such a configuration. It currently is preferred to orient structure of the brake such that a weight applied to a seat additionally energizes the engagement between the brake elements and bicycle frame tube.

Certain embodiments of the invention permit a seat to be safely elevated by a rider without necessarily requiring actuation of a release mechanism. Examples of devices having such capability include embodiments with retaining mechanisms having a one-way ratchet capability, such as plate clutches; certain gears and racks; some cartridge brakes; and pawls or plungers having a bevel or cooperating interface structure operable to retract the plunger or rotate the pawl as a post is lifted. In making a seat elevation increase with such embodiments of the invention, a rider applies force to the seat in a direction of stable and simple motion. Furthermore, the seat is held to support the rider's weight at virtually the moment the rider lets go of the seat because the retaining mechanism either immediately holds the post, or the post securely drops to its closest next lower holding elevation. Therefore, while during use of certain embodiments of the invention a rider may remove a hand from the handlebar to assist in elevating a seat, the simplicity of the necessary motion, and the minimal time required to accomplish an increase in seat elevation, permit the adjustment to be characterized as safe to accomplish while in the act of riding the bicycle.

In use of currently preferred embodiments, a release mechanism is operated by a rider without moving his hands from a handlebar, and the seat is then adjusted under assistance from the riders legs and weight, and/or a helper spring. Typically, the seat is unweighted to assist disengagement between the holding mechanism and the seat post. Operation of the release mechanism permits the post to move to a lower seat position, or until in a capture position, under the influence of a rider's weight. Preferred embodiments of the invention typically include a biasing element, such as a compression helper spring, to bias a seat post toward a high position. Therefore, when a release mechanism is actuated, and the rider is standing or otherwise unweighting the seat, the seat will be raised to a higher elevation under the extension action of the spring.

In contrast to making an elevation change for a seat using certain embodiments of the present invention, the comparatively complex operation of the commonly available clamp mechanism 148 requires a rider to reach down to a location below his seat (compromising a safe riding posture), then to apply a first considerable force onto the clamp lever in an unstable direction (generally orthogonal to both a forward and a vertical direction), then raise or lower the seat while orienting it in a forward direction, and finally, to apply a second considerable closing force onto the clamp. Sometimes, to effect a complete closure of the clamp 148, a rider must actually apply a blow to the clamp lever. Naturally, application of such a blow can contribute to causing an instability while riding the bicycle, and is unsafe. A significant amount of rider attention is required simply to locate the clamp. Applying the force required to open and close the clamp 148 can make the rider wobble or even crash, even when riding on the most gentle of surfaces.

Adjusting the elevation of a clamped bicycle seat post unavoidably occupies a considerable amount of rider time and attention. As such, the commonly available seat-post lever-clamp 148 is one mechanism that cannot be considered to be safely operable while in the act of riding a bicycle. Other such unsafe mechanisms include any release mechanism mounted to require a rider's hand to move from a handlebar to a remote location for its operation, remain in that remote location to retract the holding mechanism, and simultaneously require the rider to change the elevation of a seat.

Retaining mechanism 110, as illustrated in FIG. 5, is located under the rear part of the seat 150, but also can be oriented (subsequent to a 180 degrees rotation about post 105), for disposition under the front part of a seat. One reason to locate a mechanism 110 in such a forward orientation is to free the rear under-seat area for suspension of a seat bag or pouch. Additional advantages of such an arrangement are that a straight cable run removes the U-shaped bend near the retaining mechanism, and a shorter cable reduces weight of the device. Mechanisms such as mechanism 110 desirably are narrow enough not to interfere with a rider's legs during a pedal stroke.

Ideally, devices constructed according to principals of the invention are adapted to include a post stub, such as tube 140 (carrying the retaining mechanism), sized to replace the seat post and add an adjustable seat, which is safe to adjust while riding, to a commercially available bicycle. Alternatively, the device can be manufactured either as a part of, or for assembly to, a bicycle frame component. Also, a device can be configured for attachment to a typical bicycle frame, e.g. at the horizontal tube, to add safe adjustable elevation control for a seat to commercially available bicycles.

Holding structure, such as a plunger or a pawl, typically is manufactured from a metal or other suitably rugged material, and can be machined, cast, molded, sintered, or forged, as desired. Seat posts typically are manufactured from a metal, and can be formed from solid bars, or hollow tubes.

While the invention has been described in particular with reference to certain illustrated embodiments, such is not intended to limit the scope of the invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An adjustable bicycle seat support, comprising:
a seat post capable of attachment in telescopic and vertically adjustable relation to a frame member of a bicycle;
a retaining mechanism configured and arranged releasably to hold said post in one of a plurality of fixed vertical positions relative to said frame member, said retaining mechanism being operable to release said post to accomplish a change in elevation of said post while said retaining mechanism remains at a fixed distance from said frame member; and
a release mechanism, safely operable while a rider is in the act of riding said bicycle, said release mechanism being operable to release engagement of said retaining mechanism from said post, whereby to permit an adjustment in elevation of said post with respect to said frame member.

2. The seat support of claim 1, wherein:
said release mechanism is constructed and arranged to permit a change in seat elevation without requiring a rider to remove his hands from a handlebar of said bicycle.

3. The seat support of claim 1, wherein:
said retaining mechanism is carried on a tubular member that is adapted for telescopic registration in said bicycle frame member.

4. The seat support of claim 1, wherein:
said retaining mechanism is carried on structure associated with a frame of said bicycle.

5. The seat support of claim 1, further comprising:
alignment structure adapted to maintain a seat in an approximately forward facing direction during changes of elevation of said seat.

6. The seat support of claim 5, said alignment structure further being adapted to resist displacement of said post beyond an upper and a lower bound.

7. The seat support of claim 5, said alignment structure comprising:
a channel formed in said post; and
indexing structure configured and arranged for sliding reception in said channel as said post is raised and lowered.

8. The seat support of claim 7, wherein:
said channel and said indexing structure operate in harmony to limit a maximum displacement of said post.

9. The seat support of claim 1, said retaining mechanism being constructed and arranged with said post to permit a change in elevation of said seat, between fixed positions, of less than about ¼ inch.

10. The seat support of claim 3, wherein:
said post carries structure to interface for holding by said release mechanism at a high seat position and at a low seat position;
with said post retained at said high seat position by said release mechanism, said tubular member can be vertically adjusted with respect to said frame member and fixed in a position to locate a seat at a rider's desired high seat position; and
operation of said release mechanism permits said post to move to said low seat position under the influence of a rider's weight.

11. The seat support of claim 10, wherein:
said post is holdable, by structure carried by said retaining mechanism, at only a high position and a low position; and
the distance between said high seat position and said low seat position is a fixed increment between about 2 and about 5 inches.

12. An adjustable bicycle seat support, comprising:
a seat post;
a retaining mechanism configured and arranged releasably to hold said seat post in one of a plurality of vertical positions relative to a bicycle, and
a release mechanism, safely operable while a rider is in the act of riding said bicycle, said release mechanism being operable to release engagement of said retaining mechanism from said post, whereby to permit a telescoping adjustment in elevation of said post.

13. The seat support of claim 12, wherein:
said release mechanism is constructed and arranged to permit a change in seat elevation without requiring a rider to remove his hands from a handlebar of said bicycle.

14. The seat support of claim 12, further comprising:
alignment structure adapted to maintain a preferred orientation of said post during changes in elevation of said post.

15. The seat support of claim 14, wherein:
holding structure of said retaining mechanism can be withdrawn from engagement with receiving structure of a post while indexing structure of said retaining mechanism remains in engagement with alignment structure of said post.

16. The seat support of claim 15, wherein:
structure of said retaining mechanism is adapted for progressive engagement with receiving structure of a seat post, whereby to resist wobble of a held seat post.

17. The seat support of claim 14, wherein:
said alignment structure operates in harmony with structure of said retaining mechanism to define a maximum and a minimum height to which said seat post may be adjusted.

18. The seat support of claim 12, wherein:
a holding interface between said seat post and said retaining structure can be overridden, by a rider, to effect an increase in seat post elevation without actuating a release mechanism.

19. The seat support of claim 12, wherein:
said retaining mechanism is structured to permit an increment of change in vertical height, at which a seat post may be held, of less than about ⅛ inch.

20. An adjustable bicycle seat support, comprising:
a retaining mechanism carried on a tubular member that is adapted for telescoping registration with a bicycle frame member;
a seat post slidingly disposed in said tubular member, said retaining mechanism being configured and arranged releasably to hold said seat post in one of a plurality of positions with respect to said tubular member; and
a release mechanism, operable to release engagement between structure of said retaining mechanism and structure of said post, whereby to permit adjustment in position of said seat post.
